(19) United States
(12) Patent Application Publication
(10) Pub. No.: US 2022/0090824 A1
(43) Pub. Date: Mar. 24, 2022

(54) PORTABLE SOLAR HEATER

(71) Applicant: Patrick J. Werner, Falcon Heights, MN (US)

(72) Inventor: Patrick J. Werner, Falcon Heights, MN (US)

(21) Appl. No.: 16/379,275

(22) Filed: Apr. 9, 2019

Related U.S. Application Data
(60) Provisional application No. 62/654,678, filed on Apr. 9, 2018.

(51) Int. Cl. F24S 10/50; F24S 20/55; F24S 70/20; F24S 70/30; F24S 50/40

(52) U.S. Cl. CPC F24S 10/50; F24S 20/55; F24S 50/40; F24S 70/30; F24S 70/20

(57) ABSTRACT

A portable solar heating device that having a mat shaped flexible main body with bounded edges, the main body including a front flexible layer formed of a material transparent to electromagnetic radiation, a back flexible heat insulating layer, and a flexible electromagnetic radiation absorbing layer located between the front and back layer, the electromagnetic radiation absorbing layer including a plurality of protrusions extending towards the front flexible layer, at least one allowing ambient fluids into a fluid heating chamber located between the front layer and the electromagnetic radiation absorbing layer and at least one outlet allowing heated fluids to escape from the chamber, an electric fan attached to the outlet to assist in moving heated fluids out from the chamber, and at least one solar cell for powering the electric fan.

### CROSS REFERENCE TO RELATED APPLICATIONS

This application claims priority to currently pending U.S. Provisional Application Ser. No. 62/654,678; filed on Apr. 9, 2018; titled PORTABLE SOLAR HEATER.

### FIELD OF THE INVENTION

This invention relates generally to solar heating devices and, more specifically to a self-contained portable, weather-proof, flexible and foldable solar heating device.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The use of solar power as an alternative source of energy has gained popularity due to its various benefits including but not limited to solar power being a clean, renewable energy source having little or no maintenance costs after initial installation, and the ability to live grid free. However, some of the disadvantages of using solar energy relates to solar energy having a high initial cost for material and installation and long return of investment. In addition, current products on the market that uses solar powered energy, specifically solar powered heaters, generally lack portability and the solar power heating units are generally designed as an integral unit to an existing structure. The present invention is a portable solar heating device that solves the portability issues of prior solar powered heaters.

### SUMMARY OF THE INVENTION

The present invention is a portable solar heating device having a weather-proof, foldable mat shaped flexible main body with bounded edges. The main body includes a front flexible layer formed of a material transparent to electromagnetic radiation, a back flexible heat insulating layer, and a flexible electromagnetic radiation absorbing layer located between the front flexible layer and the back flexible heat insulating layer. The flexible electromagnetic radiation absorbing layer includes a plurality of integral laminar air flow promoting protrusions extending towards the front flexible layer.

The main body includes at least one fluid inlet located thereon that functions to allow ambient fluids to enter into a fluid heating chamber located between the front flexible layer and the flexible electromagnetic radiation absorbing layer during which the ambient fluid is heated through convective heat transfer from the electromagnetic radiation absorbing layer. The main body also includes at least one fluid outlet located on the main body and connected to and allowing heated fluids to escape from the fluid heating chamber. An electric fan is attached to the fluid outlet of the flexible main body to assist in moving the heated fluids out from the fluid heating chamber. The main body further includes at least one solar cell attached to the main body for powering the electric fan.

### BRIEF DESCRIPTION OF THE DRAWINGS

FIG. 1 shows a top view an embodiment of a portable solar heating device;

FIG. 2 shows a cross-sectional view of the portable solar heating of FIG. 1;

FIG. 3 shows a front view showing an ice fishing house with portable solar heating devices attached to a roof of the ice fishing house;

FIG. 4 is a perspective view showing the use of an alternative embodiment of a portable solar heating device;

FIG. 5 shows a partial peel-away of the portable solar heating device of FIG. 4;

FIG. 6 shows a partial cross-sectional view of the portable solar heating device of FIG. 4;

FIG. 7 shows a partial peel-away view of an alternative embodiment of a portable solar heating device;

and FIG. 8 shows a partial cross-sectional view of the portable solar heating device 32 of FIG. 7;

FIG. 9 is a top showing an alternative embodiment of a portable solar heating device; and

FIG. 9A is a side view showing the portable solar heating device of FIG. 9.

### DESCRIPTION OF THE PREFERRED EMBODIMENT

The present provides a niche to the ever-expanding use of solar energy to everyday applications by providing a self-contained portable, weather-proof, flexible and foldable solar heating device that has various everyday applications. Some advantages of the present systems of the present invention is that the present system is light weight and portable, flexible, heats fresh ambient fluid instead of a recycled fluid, is not required to be permanently coupled to a housing or support structure, and contains no gasket or brackets thereby prolonging the use life of the device.

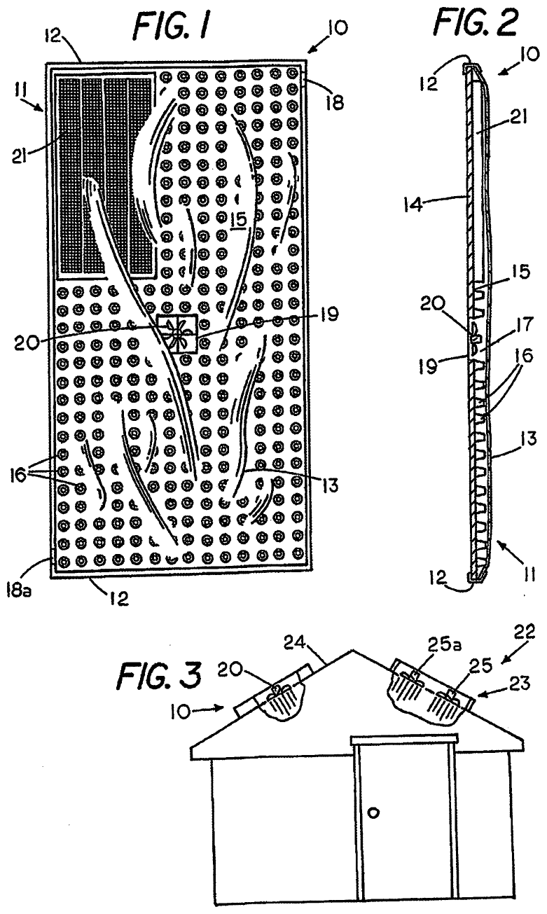

Referring to FIGS. 1 and 2, FIG. 1 shows a top view and FIG. 2 shows a cross-sectional view of an embodiment of a portable solar heating device 10 of the present invention. Portable solar heating device 10 includes a weather-proof, foldable mat shaped flexible main body 11 having bounded edges 12 and form from a metal-free material. Although the size of portable solar heating device 10 may vary, depending of the desired application, an example of a dimensioned of portable solar heating device 10 may comprise 4 (four) feet by 8 (eight) feet due to the standard size for materials.

Main body 11 includes a front flexible layer 13 formed of a material transparent to electromagnetic radiation, a back flexible heat insulating layer 14, and a flexible electromagnetic radiation absorbing layer 15 located between the front flexible layer 13 and the back flexible heat insulating layer 14. Front flexible layer 13 may include an anti-reflective material to enhance front flexible layer 13's transparency and provides two main function in the operation of the portable solar heating device 10, namely front flexible layer 13 allows the electromagnetic radiation from the sun to transmit therethrough and while also acting as a partial barrier to keep heated fluids from dissipating therethrough into the atmosphere.

A feature of the flexible electromagnetic radiation absorbing layer 14 is that the flexible electromagnetic radiation absorbing layer 14 comprises a color that absorbs a majority if not all of the wavelengths of light. For example, the color black is known to absorb all wavelengths of light. The aforementioned color may either be integrally formed into the flexible electromagnetic radiation absorbing layer 14 or alternative is in the form of a paint applied thereto.

Another feature of the flexible electromagnetic radiation absorbing layer 14 is that the flexible electromagnetic radiation absorbing layer 14 includes a plurality of integral laminar air flow promoting protrusions 16 extending towards the front flexible layer 13. Although the protrusions 16 are shown in the embodiment of FIGS. 1 and 2 as comprising cone-shaped, it is noted that alternative embodiments of the portable solar heating device may include integral laminar air flow promoting protrusions have various shapes and sizes, depending on the intended application for the portable solar heating device.

The flexible main body 11 also includes at least one fluid inlet located on the main body 11 with the fluid inlet functioning to allow ambient fluids to enter into a fluid heating chamber 17 located between front flexible layer 13 and flexible electromagnetic radiation absorbing layer 15. The embodiment of FIGS. 1 and 2 shows the fluid inlet as comprising a pair of fluid inlets 18, 18a.

The fluid inlets are preferably positioned or located sufficiently distal to the fluid outlet to allow fluids within the fluid heating chamber to properly heat the fluids therein to ensure optimal warming of the fluids supported within the fluid heating chamber before the heated fluid exist the fluid heating chamber. For example, maximize the efficiency of the fluid heating chamber 17, the fluid inlet in some embodiments of the present invention, is preferably located distal to the outlet 19 of main body 11.

In operation, the front flexible layer 13 allows the electromagnetic radiation from the sun to transmit therethrough, striking flexible electromagnetic radiation absorbing layer 14 wherein the electromagnetic radiation is then absorbed by the flexible electromagnetic radiation absorbing layer 14 and converted to heat energy. While in the fluid heating chamber 17 the ambient fluid is heated through convective heat transfer from the electromagnetic radiation absorbing layer 15. The heated fluid is prevented from dissipating into the atmosphere by the flexible main body 11. The working model of the present invention reveals that the solar panel of the present invention has the capacity to heat the fluid within the fluid heating chamber at least 100-125 degrees Fahrenheit above ambient temperature.

The flexible main body 11 further includes at least one fluid outlet 19 located on the main body 11 and connected to and allowing heated fluids to escape from the fluid heating chamber 17. FIGS. 1 and 2 show fluid outlet 19 located on the back flexible heat insulating layer 14. Attached to the outlet 19 of the flexible main body 11 is an electric fan 20 which functions to assist in moving the heated fluids out from the fluid heating chamber 17. An example of a workable size fan may comprise a one inch to two-inch radial fan that may be powered by as little as 2-4 watts and supported by a 12-volt or 18-volt battery.

It is noted that although electric fan 20 is shown in the embodiment of FIGS. 1 and 2 as comprising a radial fan, the electric fan may alternatively comprise a bladeless fan. Electric fan 20 may also include a temperature sensor for turning on electric fan 20 when the heated fluids located within chamber 17 reaches a preset temperature and turning off electric fan 20 when the heated fluid dips below the present temperature.

The flexible main body 11 is shown to also include at least one solar cell and preferably a plurality of solar cells forming a solar panel 21 attached to said main body for powering the electric fan 20.

FIG. 3 shows a front view of a shack or ice fishing house 22 having portable solar heating device 10 and a second portable solar heating device 23 attached to a roof 24 of ice fishing house 22. The difference between portable solar heating device 10 and a second portable solar heating device 23 is that portable solar heating device 10 comprises a one electric fan system whereas second portable solar heating device 23 comprises a dual electric fan system. Other applications for portable solar heating devices 10 and 23 may include but not limited to temporary installation of portable solar heating devices 10 and 23 to the windows of a recreational vehicle, a shed, an apartment or a house to provide an off the grid free source of daytime heat. Portable solar heating devices 10 and 23 may be mounted to or incorporated into a portable temporary housing structure such as a tent, hunting blinds or a day time pop-up structures such as ice fishing houses and hunting huts to provide a temporary heat shelter when temperatures drop down to the 20s or 30s degree Fahrenheit. Portable solar heating devices 10 and 23 may also be temporarily mounted to automobile windows, such as through the use of suction cups, to warm the interiors of the automobile during the daytime while the driver is at work.

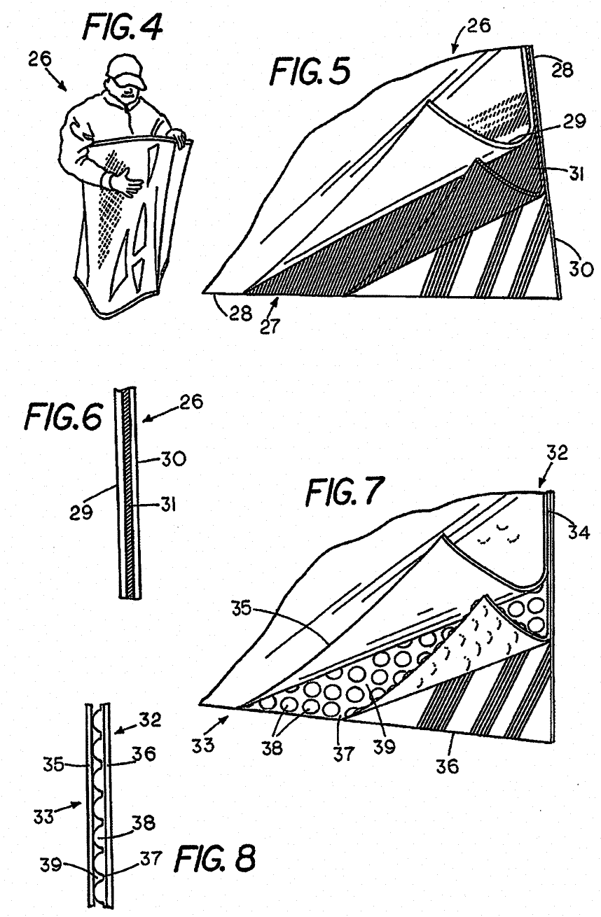

Referring to FIGS. 4, 5, and 6, FIG. 4 is a perspective view showing the use of an alternative embodiment of a portable solar heating device 26 of the present invention. FIG. 5 shows a partial peel-away view and FIG. 6 shows a partial cross-sectional view of portable solar heating device 26.

Portable solar heating device 26 generally includes a weather-proof, foldable and flexible main body 27 having bounded edges 28. Main body 27 includes a front flexible layer 29 formed of a material transparent to electromagnetic radiation, a back flexible heat retention layer 30 formed of a metalized plastic, and a flexible electromagnetic radiation absorbing layer 31 located between front flexible layer 29 and said back flexible heat retention layer 30. In the embodiment of FIGS. 4-6 the back flexible heat retention layer 30 is shown comprising a silver-foil.

Similar to the embodiment of FIGS. 1-3, a feature of the flexible electromagnetic radiation absorbing layer 31 is that the flexible electromagnetic radiation absorbing layer 31 comprises a color that absorbs a majority if not all of the wavelengths of light and the front flexible layer 29 may include an anti-reflective material.

In regards to applications for portable solar heating device 26, although FIG. 4 shows portable solar heating device 26 as being use as a blanket, portable solar heating device 26 may also be use, such as by alteration during the manufacturing process, as an article of clothing.

Referring to FIGS. 7 and 8, FIG. 7 shows a partial peel-away view and FIG. 8 shows a partial cross-sectional view of an alternative embodiment of a portable solar heating device 32 of the present invention. Portable solar heating device 32 generally includes a weather-proof and foldable mat shaped flexible main body 33 having bounded edges 34 with the main body 33 including a front flexible layer 35 formed of a material transparent to electromagnetic radiation, a back flexible heat retention layer 36 formed of a metalized plastic such as a silver foil, and a flexible electromagnetic radiation absorbing layer 37 located between front flexible layer 35 and back flexible heat retention layer 36. It is noted that in alternative embodiments the back flexible heat retention layer 36 may be replaced with a back flexible heat insulating layer similar to the back flexible heat insulating layer 14 of FIGS. 1-2.

Located between front flexible layer 35 and flexible electromagnetic radiation absorbing layer 37 is a fluid heating chamber 39, which functions to heat a fluid located therein through convective heat transfer from the electromagnetic radiation absorbing layer 37. Also located within the fluid heating chamber 39 are a plurality of self-contained pockets of fluids 38 formed from the flexible electromagnetic radiation absorbing layer 37 and extending to provide the main body 33 with cushioning support against a support surface.

Then operation of portable solar heating device 32 is similar to the operation of portable solar heating device 10 in that the front flexible layer 35 allows the electromagnetic radiation from the sun to transmit therethrough, striking flexible electromagnetic radiation absorbing layer 37 wherein the electromagnetic radiation is then absorbed by the flexible electromagnetic radiation absorbing layer 37 and converted to heat energy. Fluids located in the fluid heating chamber 39 along with fluids located within the plurality of self-contained pockets of fluids 38 are heated through convective heat transfer from the electromagnetic radiation absorbing layer 37. The heated fluid are prevented from dissipating into the atmosphere by the flexible main body 35 and by an exterior surface of each of the self-contained pockets of fluids 38. Since there are no outlet for the heat fluid to exit portable solar heating device 32, the heated fluid located within portable solar heating device 32 is able to maintain a higher temperature for a long duration.

In regards to applications for portable solar heating device 32, an example of a possible use for portable solar heating 32 may a multi-use floatable beach mat for laying and tanning on grass, sand or on the water.

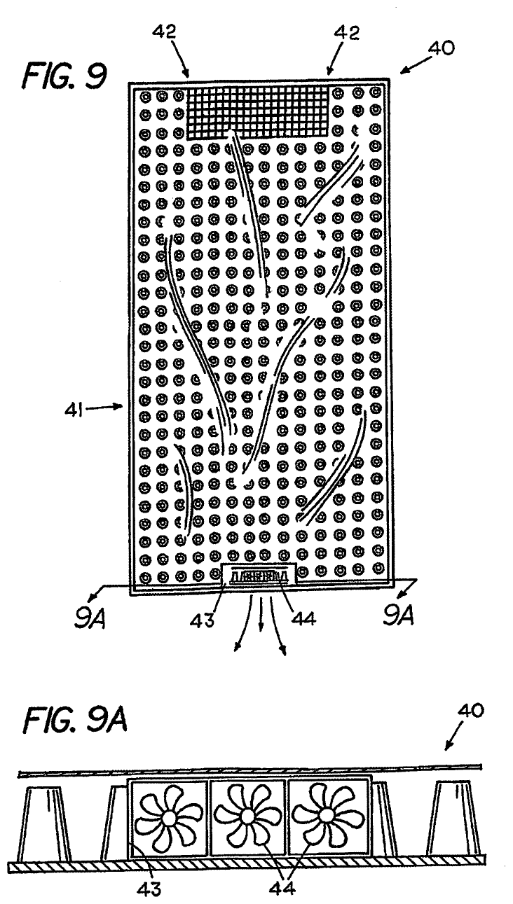

Referring to FIGS. 9 and 9A, FIG. 9 is a top view and 9A is a side view showing an embodiment of a portable solar heating device 40 having similar components to the portable solar heating device 10 of FIGS. 1-3. However, in the embodiment of FIGS. 9 and 9A, portable solar heating device 40 is shown with a weather-proof, foldable mat shaped flexible main body 41 having a pair of fluid inlets 42 located on a first end 41a of main body 41 and a fluid outlet 43 located at a second, distal end 41b of main body 41. FIGS. 9 and 9A further shows a set of three electric radial fans 44 attached to fluid outlet 43 in a condition that that allows electric radial fans to move heated fluids out from a fluid heating chamber in an axial direction or path with respect to main body 41.

I claim:

1. A portable solar heating device comprising:
a weather-proof, foldable mat shaped flexible main body having bounded edges, said main body including a front flexible layer formed of a material transparent to electromagnetic radiation, a back flexible heat insulating layer, and a flexible electromagnetic radiation absorbing layer located between said front flexible layer and said back flexible heat insulating layer, said flexible electromagnetic radiation absorbing layer including a plurality of integral laminar air flow promoting protrusions extending towards said front flexible layer;
at least one fluid inlet located on said main body, said at least one fluid inlet allowing ambient fluids to enter into a fluid heating chamber located between said front flexible layer and said flexible electromagnetic radiation absorbing layer during which said ambient fluid is heated through convective heat transfer from said electromagnetic radiation absorbing layer;
at least one fluid outlet located on said main body, said at least one fluid outlet connected to and allowing heated fluids to escape from said chamber;
an electric fan attached to said at least one fluid outlet of said flexible main body to assist in moving said heated fluids out from said chamber; and
at least one solar cell attached to said main body for powering said electric fan.

2. The portable solar heating device of claim 1 wherein said electric fan comprises a radial fan.

3. The portable solar heating device of claim 1 wherein said electric fan comprises a bladeless fan.

4. The portable solar heating device of claim 1 wherein said at least one solar cell comprise a plurality of solar cells forming a solar panel attached to said main body for powering said electric fan.

5. The portable solar heating device of claim 1 wherein said at least one inlet is located distal to said at least one outlet of said main body.

6. The portable solar heating device of claim 1 wherein said electric fan moves said heated fluids out from said chamber in an axial direction with respect to said main body.

7. The portable solar heating device of claim 1 wherein said fluid outlet is located on said back flexible heat insulating layer.

8. The portable solar heating device of claim 1 wherein said flexible electromagnetic radiation absorbing layer supports a paint thereon that absorbs all wavelengths of light.

9. The portable solar heating device of claim 1 wherein said front flexible layer includes an anti-reflective material.

10. The portable solar heating device of claim 1 wherein said electric fan includes a temperature sensor for turning on said electric fan when said heated fluids located within said chamber reaches a preset temperature and turning off said electric fan when said heated fluid dips below said present temperature.

11. The portable solar heating device of claim 1 wherein said main body is form from a metal-free material.

12. A portable solar heating device comprising:
a weather-proof, foldable and flexible main body having bounded edges, said main body including a front flexible layer formed of a material transparent to electromagnetic radiation, a back flexible heat retention layer formed of a metalized plastic, and a flexible electromagnetic radiation absorbing layer located between said front flexible layer and said back flexible heat retention layer.

13. The portable solar heating device of claim 12 wherein said back flexible heat retention layer comprises a silver foil.

14. The portable solar heating device of claim 13 wherein said flexible electromagnetic radiation absorbing layer supports a paint thereon that absorbs all wavelengths of light and said front flexible layer includes an anti-reflective material.

15. The portable solar heating device of claim 14 wherein said main body comprises a blanket.

16. The portable solar heating device of claim 14 wherein said main body comprises an article of clothing.

17. A portable solar heating device comprising:
a weather-proof and foldable mat shaped flexible main body having bounded edges, said main body including a front flexible layer formed of a material transparent to electromagnetic radiation, a back flexible heat retention layer formed of a metalized plastic, and a flexible electromagnetic radiation absorbing layer located between said front flexible layer and said back flexible heat retention layer;
a fluid heating chamber located between said front flexible layer and said flexible electromagnetic radiation absorbing layer during which a fluid located therein is heated through convective heat transfer from said electromagnetic radiation absorbing layer; and
a plurality of self-contained pockets of fluids formed from said flexible electromagnetic radiation absorbing layer and extending into said heating chamber to provide said main body with cushioning support against a support surface.

18. The portable solar heating device of claim 17 wherein said back flexible heat retention layer comprises a silver foil.

19. The portable solar heating device of claim 18 wherein said flexible electromagnetic radiation absorbing layer supports a paint thereon that absorbs all wavelengths of light and said front flexible layer includes an anti-reflective material.

20. The portable solar heating device of claim 18 wherein said flexible main body comprises a multi-use floatable beach mat.
